(19) United States
(12) Patent Application Publication
(10) Pub. No.: US 2026/0127359 A1
(43) Pub. Date: May 7, 2026

(54) TABLE DATA PROCESSING METHOD, ELECTRONIC DEVICE, AND NON-TRANSITORY STORAGE MEDIUM

(71) Applicant: Beijing Zitiao Network Technology Co., Ltd., Beijing (CN)

(72) Inventor: Xupan LI, Beijing (CN)

(21) Appl. No.: 19/380,735

(22) Filed: Nov. 5, 2025

(30) Foreign Application Priority Data
Nov. 7, 2024 (CN) 202411586995.4

(51) Int. Cl. G06F 40/177; G06F 16/22

(52) U.S. Cl. CPC G06F 40/177; G06F 16/2282

(57) ABSTRACT

The present disclosure provides a table data processing method, an electronic device and a non-transitory storage medium. The method includes: displaying at least part of records of a first table in a first interface of a client in response to a data access request for the first table input in the client, where the records are rows of data in the first table; and receiving a sub-record editing operation for the first table through the first interface, determining hierarchical description data corresponding to an edited sub-record according to the sub-record editing operation, and updating display data of the first table in the first interface according to the hierarchical description data, where the hierarchical description data is used to describe parent-child relationship data corresponding to the sub-record in the first table and a parent record including the sub-record.

### CROSS-REFERENCE TO RELATED APPLICATION

This application claims the priority to and benefits of the Chinese Patent Application No. 202411586995.4, which was filed on November 7, 2024. The aforementioned patent application is hereby incorporated by reference in its entirety.

### TECHNICAL FIELD

Embodiments of the present disclosure relate to the field of computer processing technologies, and in particular, to a table data processing method, an electronic device, and a non-transitory storage medium.

### BACKGROUND

With the rapid development of information technology, tables have become an indispensable part of all walks of life, carrying a large amount of information in an intuitive and clear way. Users may store, manage, and view data records through tables.

For viewing data records through a table, the table data processing method in the related art often loads all data records at once according to a data access request for the table, and reloads all data records when the data records change. However, when the amount of data is very large (for example, on the order of millions of rows), loading all the data at once may cause the client to bear huge memory and computing pressure, making the table processing efficiency low and the user experience poor.

### SUMMARY

Embodiments of the present disclosure provide a table data processing method, an apparatus, a device, a medium, and a product, which may display records of a table on demand and may update changed records more quickly and effectively in a targeted manner, thereby improving the processing efficiency and use experience of the table.

An embodiment of the present disclosure provides a table data processing method, including:

displaying at least part of records of a target table (for example, a first table) in a target interface (for example, a first interface) of a client in response to a data access request for the target table input in the client, where the records are rows of data in the target table; and

receiving a sub-record editing operation for the target table through the target interface, determining hierarchical description data corresponding to an edited sub-record according to the sub-record editing operation, and updating display data of the target table in the target interface according to the hierarchical description data, where the hierarchical description data is used to describe parent-child relationship data corresponding to a sub-record in the target table and a parent record including the sub-record.

An embodiment of the present disclosure further provides a table data processing apparatus, including:

a data access request module, configured to display at least part of records of a target table in a target interface of a client in response to a data access request for the target table input in the client, where the records are rows of data in the target table; and

a table data display module, configured to receive a sub-record editing operation for the target table through the target interface, determine hierarchical description data corresponding to an edited sub-record according to the sub-record editing operation, and update display data of the target table in the target interface according to the hierarchical description data, where the hierarchical description data is used to describe parent-child relationship data corresponding to a sub-record in the target table and a parent record including the sub-record.

An embodiment of the present disclosure further provides an electronic device, including:

one or more processors; and

a storage apparatus, configured to store one or more programs,

when the one or more programs are executed by the one or more processors, the one or more processors are caused to implement the table data processing method according to any one of the embodiments of the present disclosure.

An embodiment of the present disclosure further provides a storage medium including computer-executable instructions, where the computer-executable instructions, when executed by a computer processor, are configured to perform the table data processing method according to any one of the embodiments of the present disclosure.

An embodiment of the present disclosure further provides a computer program product, including a computer program, where the computer program, when executed by a processor, implements the table data processing method according to any one of the embodiments of the present disclosure.

### BRIEF DESCRIPTION OF DRAWINGS

The above and other features, advantages, and aspects of the embodiments of the present disclosure will become more apparent in combination with the drawings and with reference to the following specific embodiments. Throughout the drawings, the same or similar reference numbers refer to the same or similar elements. It should be understood that the drawings are schematic and that the components and elements are not necessarily drawn to scale.

FIG. 1 is a schematic flowchart of a table data processing method according to an embodiment of the present disclosure;

FIG. 2 is a schematic flowchart of another table data processing method according to an embodiment of the present disclosure;

FIG. 3 is a schematic flowchart of another table data processing method according to an embodiment of the present disclosure;

FIG. 4 is a schematic flowchart of another table data processing method according to an embodiment of the present disclosure;

FIG. 5 is an example interface diagram of record display applicable to the table data processing method according to an embodiment of the present disclosure;

FIG. 6 is a schematic timing diagram of on-demand loading of responsive table data applicable to the table data processing method according to an embodiment of the present disclosure;

FIG. 7 is an example interface diagram of record operation applicable to the table data processing method according to an embodiment of the present disclosure;

FIG. 8 is a schematic timing diagram of responsive sub-record editing operation applicable to the table data processing method according to an embodiment of the present disclosure;

FIG. 9 is a schematic structural diagram of a table data processing apparatus according to an embodiment of the present disclosure; and

FIG. 10 is a schematic structural diagram of an electronic device according to an embodiment of the present disclosure for implementing the embodiments of the present disclosure.

### DETAILED DESCRIPTION

Hereinafter, embodiments of the present disclosure will be described in more detail with reference to the drawings. Although some embodiments of the present disclosure are shown in the drawings, it should be understood that the present disclosure may be implemented in various forms and should not be construed as being limited to the embodiments set forth herein; on the contrary, these embodiments are provided for a more thorough and complete understanding of the present disclosure. It should be understood that the drawings and embodiments of the present disclosure are only for exemplary purposes, rather than limiting the protection scope of the present disclosure.

It should be understood that steps described in method implementations of the present disclosure may be performed in different orders and/or in parallel. Furthermore, the method implementations may include additional steps and/or omit the execution of illustrated steps. The scope of the present disclosure is not limited in this regard.

The term "include/comprise" and its variations used herein are open-ended inclusions, that is, "include/comprise but not limited to". The term "based on" is "at least partially based on". The term "one embodiment" means "at least one embodiment"; the term "another embodiment" means "at least one other embodiment"; the term "some embodiments" means "at least some embodiments". Relevant definitions of other terms will be given in the following description.

It should be noted that concepts such as "first" and "second" mentioned in the present disclosure are only used to distinguish different apparatuses, modules, or units, rather than limiting an order or interdependence of functions performed by these apparatuses, modules, or units.

It should be noted that modifications of "one" and "multiple" mentioned in the present disclosure are illustrative rather than restrictive, and those skilled in the art should understand that unless otherwise explicitly specified in the context, they should be understood as "one or more".

The names of messages or information exchanged between multiple apparatuses in the implementations of the present disclosure are only for illustrative purposes, rather than limiting the scope of these messages or information.

It may be understood that before using the technical solutions disclosed in the embodiments of the present disclosure, the user should be informed of the type, range of use, use scenarios, etc. of personal information involved in the present disclosure, and the authorization of the user should be obtained in an appropriate manner in accordance with relevant laws and regulations.

For example, in response to receiving an active request from a user, prompt information is sent to the user to clearly inform the user that the requested operation will require access to and use of the user’s personal information. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It should be understood that the above process of notifying the user and obtaining the authorization of the user is only illustrative, and does not limit the implementations of the present disclosure. Other manners that satisfy the relevant laws and regulations may also be applied in the implementations of the present disclosure.

It should be understood that the data involved in the technical solution (including but not limited to the data itself, acquisition or use of the data) should comply with requirements of corresponding laws, regulations, and related provisions.

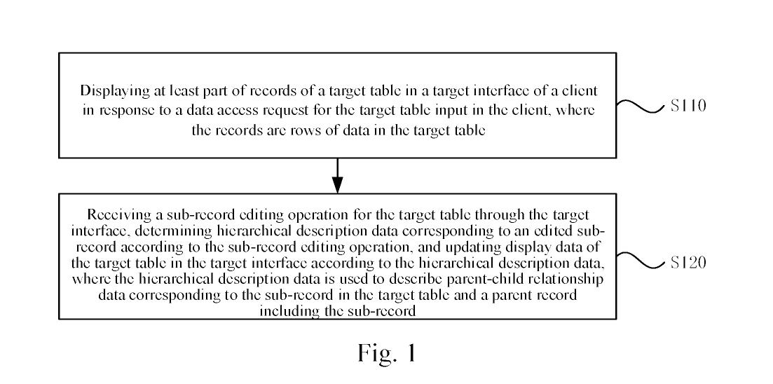

FIG. 1 is a schematic flowchart of a table data processing method according to an embodiment of the present disclosure. The embodiment of the present disclosure is applicable to a scenario of processing table data. The method may be performed by a table data processing apparatus, which may be implemented in the form of software and/or hardware, optionally, in an electronic device. The electronic device may be a mobile terminal, a PC, a server, or the like. As shown in FIG. 1, the method in this embodiment may specifically include the following steps S110 and S120.

At step S110, display at least part of records of a target table in a target interface of a client in response to a data access request for the target table input in the client, where the records are rows of data in the target table.

The target table may be understood as a table for which data access is required, and may be used to store, manage, and display data records. Data in the target table may be presented in the form of rows. The records may refer to data recorded in a row in the target table. In practical applications, the target table usually includes multiple rows of data, that is, the target table usually includes multiple records. In the embodiment of the present disclosure, the records in the target table may have a parent-child relationship. The target table may include one or more parent records and one or more sub-records subordinate to the parent records. It should be noted that the number of sub-records under different parent records in the target table may be the same or may be different.

In the embodiment of the present disclosure, the data access request may be understood as a request for performing data access on the data in the target table, and may be used to display at least part of the records of the target table in the target interface of the client. In the embodiment of the present disclosure, the target interface may be understood as an interface for displaying the at least part of the records of the target table. In the embodiment of the present disclosure, the target interface may be adaptively laid out in a responsive layout manner to adapt to display screens of different resolutions; or may be laid out in a preset interface size, where the preset interface size may be set according to actual needs and is not specifically limited herein. Optionally, the preset interface size includes a preset interface length and/or a preset interface width.

In the embodiment of the present disclosure, an application scenario of the data access request for the target table input in the client may be a case where no record of the target table is displayed on the target interface of the client; or may be a case where the record of the target table is displayed on the target interface of the client.

As an optional implementation of the present disclosure, the displaying at least part of records of a target table in a target interface of a client in response to a data access request for the target table input in the client may specifically be: in response to that no record of the target table is displayed on the target interface of the client, responding to a data viewing operation for the target table input in the client. Based on this, after the data viewing operation for the target table input in the client is received, a default loading record of the target table may be determined. Then, the default loading record may be displayed in the target interface of the client. The default loading record may be understood as a default record that needs to be displayed when the target table is accessed for the first time within a preset time period. For example, the default loading record may be a record of the target table displayed on the target interface when the target table was closed last time.

In the embodiment of the present disclosure, determining at least part of default records of the target table may be determined based on a preset record identifier and a preset number of displayed records of the target table, where the preset record identifier may be used to distinguish data content in different tables of the target interface. For example, the preset record identifier may be a first record displayed in the target table. In some scenarios, the preset record identifier is referred to as a column title, which is used to identify data content of data in a column in which the preset record identifier is located, or to distinguish data content of different columns. The preset record identifier may be set according to actual needs and is not specifically set here. The preset number of displayed records may be set according to actual needs and is not specifically limited here, for example, 20, 30, or 50, etc. It may be understood that the preset number of displayed records does not exceed an upper limit of the number of records that may be displayed on the target interface.

As another optional implementation of the present disclosure, the displaying at least part of records of a target table in a target interface of a client in response to a data access request for the target table input in the client may specifically be: in response to that the record of the target table is displayed on the target interface of the client, responding to a scroll operation for the target interface displaying the record of the target table. Based on this, after the scroll operation for the target interface displaying the record of the target table is received, the displaying at least part of the records of the target table displayed in the target interface of the client may be updated.

In the embodiment of the present disclosure, a storage location of the records of the target table may be the client, or may be a server. There may be multiple manners to display the at least part of the records of the target table in the target interface of the client.

As an optional implementation of the present disclosure, in response to that the storage location of the records of the target table is the client, after the data access request for the target table input in the client is received, the at least part of the records of the target table may be read from the client, and the at least part of the records are displayed in the target interface of the client.

As another optional implementation of the present disclosure, in the case where the storage location of the records of the target table is a server, the displaying at least part of records of a target table in a target interface of a client in response to a data access request for the target table input in the client may include: in response to the data access request for the target table input in the client, obtaining target data corresponding to a record requested to be accessed from table data of the target table stored in the server, and caching the target data in the client; and displaying the target table in the target interface of the client according to the target data cached in the client.

The target data may be understood as table data corresponding to the data access request for the target table stored in the server. Specifically, after the data access request for the target table input in the client is received, the data access request may be sent to the server. Then, the target data corresponding to the record requested to be accessed may be acquired from the table data of the target table stored in the server. After the target data of the server is acquired, the target data may be stored in the cache of the client. Then, the target table may be displayed in the target interface of the client according to the target data cached in the client. In general, the target data is data displayed in the target interface, that is, table data that needs to be rendered by a view layer.

Based on the preceding embodiments, to facilitate subsequent access to the target table through the client, after the client receives the target data sent by the server, the target data of the target table may be stored in a preset storage location. On this basis, to reduce the occupancy of the storage space of the client, when the client receives the target data of the target table sent by the server, a reception time of the target data may be marked. If no data access request for the target table is input in the client within a preset time period from the reception time, the target data stored in the client may be deleted.

At step S120, receive a sub-record editing operation for the target table through the target interface, determine hierarchical description data corresponding to an edited sub-record according to the sub-record editing operation, and updating display data of the target table in the target interface according to the hierarchical description data, where the hierarchical description data is used to describe parent-child relationship data corresponding to the sub-record in the target table and a parent record including the sub-record.

The sub-record editing operation may be understood as an operation for editing the sub-record in the target table. In the embodiment of the present disclosure, the sub-record editing operation may include a sub-record adding operation and/or a sub-record deleting operation. The sub-record adding operation may be understood as an operation for adding at least one sub-record in the target table. The sub-record deleting operation may be understood as an operation for deleting at least one sub-record in the target table. In the embodiment of the present disclosure, the hierarchical description data may be used to describe the parent-child relationship data corresponding to the sub-record in the target table and the parent record including the sub-record. In other words, the hierarchical description data may be used to determine the parent record to which the sub-record belongs and all sub-records under the parent record.

In the embodiment of the present disclosure, a storage location of the hierarchical description data may be the client, or may be the server. There are multiple manners to determine the hierarchical description data corresponding to the edited sub-record according to the sub-record editing operation.

As an optional implementation of the present disclosure, in the case where the storage location of the hierarchical description data may be the client, the edited sub-record may be determined according to the sub-record editing operation. Then, the hierarchical description data corresponding to the edited sub-record in the client may be updated based on the edited sub-record. Thus, the hierarchical description data corresponding to the edited sub-record may be read from the client.

As another optional implementation of the present disclosure, in the case where the storage location of the hierarchical description data may be the server, the edited sub-record may be determined according to the sub-record editing operation. After the edited sub-record is determined, the edited sub-record may be sent to the server, so that the server updates the hierarchical description data corresponding to the edited sub-record and sends the updated hierarchical description data to the client, so that the client obtains the hierarchical description data corresponding to the edited sub-record.

In the embodiment of the present disclosure, the updating display data of the target table in the target interface according to the hierarchical description data may specifically include: determining, according to the hierarchical description data, a parent record to which the edited sub-record belongs and all sub-records under the parent record. Thus, the display data of the target table in the target interface may be updated based on the parent record to which the edited sub-record belongs and all the sub-records under the parent record.

In the embodiment of the present disclosure, the hierarchical description data may include first description data and second description data. The first description data may be used to describe a subordinate relationship between the sub-record and the parent record to which the sub-record belongs. The second description data may be used to describe a subordinate relationship between the parent record and sub-records included in the parent record. In the embodiment of the present disclosure, the advantage of using the first description data and the second description data as the hierarchical description data is that when a sub-record is added under or deleted from a certain parent record of the target table displayed in the target interface, there is no need to reload all records of the target table, and the changed record in the target table may be loaded in a targeted manner. In addition, the records of the target table may be loaded and displayed in the target interface on demand more quickly and effectively.

In the embodiment of the present disclosure, the hierarchical description data is stored in the form of a key-value pair (Map). The first description data may use an identifier of the sub-record as a key and an identifier of the parent record to which the sub-record belongs as a value. The second description data may use an identifier of the parent record as a key and identifiers of the sub-records subordinate to the parent record as values. In the embodiment of the present disclosure, two Maps are used, one for storing a mapping from the sub-record to the parent record, that is, the first description data, and the other for storing a mapping from the parent record to the sub-record, that is, the second description data, which realizes flat data storage of the records in the target table, reduces the nesting level of the data, makes data access more direct and addition, deletion, and modification of the records more flexible, and may conveniently update the parent-child relationship between the parent record and the sub-record in the target table without reconstructing the entire data structure. In addition, it also avoids duplicate storage of data and is easy to understand and maintain.

Based on the preceding embodiments, the determining hierarchical description data corresponding to an edited sub-record according to the sub-record editing operation may specifically include: in response to that the sub-record editing operation includes a sub-record adding operation, adding first description data corresponding to an added sub-record, and writing description data corresponding to the added sub-record into second description data of a parent record to which the added sub-record belongs; and/or, in response to that the sub-record editing operation includes a sub-record deleting operation, deleting first description data corresponding to the added sub-record, and deleting description data corresponding to the added sub-record from second description data of a parent record to which the added sub-record belongs. With the technical solution, the sub-record may be simply and quickly deleted, the processing rate of the target table may be improved, and the view update speed may be improved after the sub-record is deleted.

Based on the preceding embodiments, an embodiment of the present disclosure may further include: the client may include a current client and a collaborating client collaborating with the current client. In the embodiment of the present disclosure, there may be one, two or more collaborating clients. The current client and the collaborating client respectively establish a data communication link with the server based on a network communication protocol (such as Websoket). After the collaborating client receives the sub-record editing operation for the target table, the collaborating client may send the sub-record editing operation to the server, so that the server broadcasts, to clients communicatively linked to the server, a message of the sub-record editing operation by the collaborating client for the target table. After the current client acquires the message from the data communication link, the sub-record editing operation by the collaborating client for the target table may be obtained based on the message. Then, the sub-record editing operation by the collaborating client for the target table may be performed on the target table of the current client, thereby realizing the function of multi-client collaborative processing of the sub-record editing operation for the target table.

According to the technical solution of the embodiments of the present disclosure, at least part of records of a target table are displayed in a target interface of a client in response to a data access request for the target table input in the client, and since the records are rows of data in the target table, the records of the target table are displayed on demand. A sub-record editing operation for the target table is received through the target interface, and hierarchical description data corresponding to an edited sub-record is determined according to the sub-record editing operation. In the technical solution, by defining the hierarchical description data that describes parent-child relationship data corresponding to a sub-record in the target table and a parent record including the sub-record, the nesting level of the records in the target table is reduced, and the data structure of the target table is simplified. After that, the display data of the target table in the target interface may be updated more quickly and specifically according to the hierarchical description data. The technical solution of the embodiments of the present disclosure solves the technical problem of low table processing efficiency in existing table processing, realizes that the records of the table may be loaded on demand and the changed records may be updated more quickly and effectively in a targeted manner without loading all data of the target table, supports quick editing and display of sub-records in a scenario of displaying the table on demand, and improves the processing efficiency and use experience of the target table.

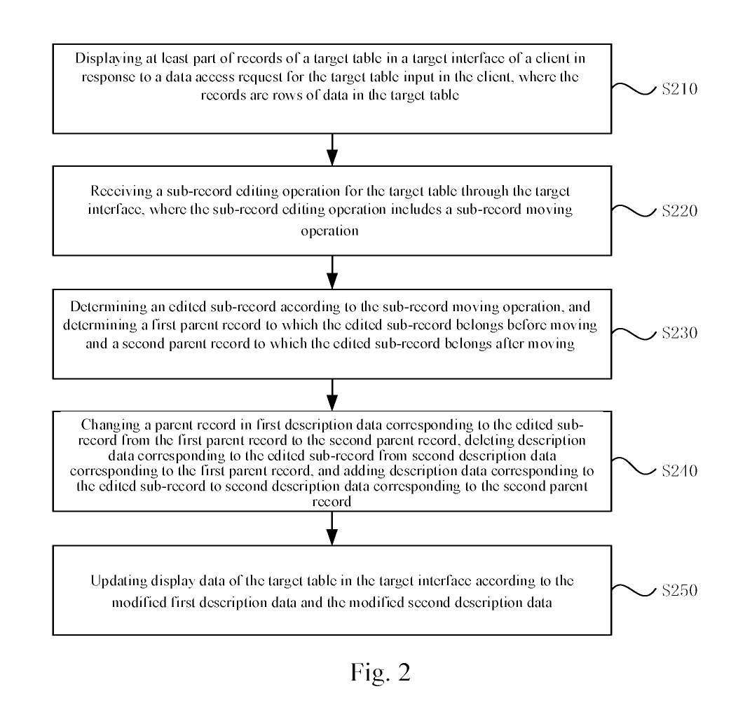

FIG. 2 is a schematic flowchart of another table data processing method according to an embodiment of the present disclosure. Based on the preceding embodiments, in the technical solution of this embodiment, the sub-record editing operation includes a sub-record moving operation, and the determining hierarchical description data corresponding to an edited sub-record according to the sub-record editing operation includes: determining the edited sub-record according to the sub-record moving operation, and determining a first parent record to which the edited sub-record belongs before moving and a second parent record to which the edited sub-record belongs after moving; and changing a parent record in first description data corresponding to the edited sub-record from the first parent record to the second parent record, deleting description data corresponding to the edited sub-record from second description data corresponding to the first parent record, and adding description data corresponding to the edited sub-record to second description data corresponding to the second parent record. For the specific implementation, reference may be made to the description of this embodiment. The technical features the same as or similar to those of the preceding embodiments are not repeated here. As shown in FIG. 2, the method in this embodiment may specifically include the following steps S210 to S250.

At step S210, display at least part of records of a target table in a target interface of a client in response to a data access request for the target table input in the client, where the records are rows of data in the target table.

At step S220, receive a sub-record editing operation for the target table through the target interface, where the sub-record editing operation includes a sub-record moving operation.

The sub-record moving operation may be understood as an operation for moving or adjusting the position of at least one sub-record in the target table.

At step S230, determine an edited sub-record according to the sub-record moving operation, and determine a first parent record to which the edited sub-record belongs before moving and a second parent record to which the edited sub-record belongs after moving.

The first parent record may be understood as a parent record to which the edited sub-record belongs before moving. The second parent record may be understood as a parent record to which the edited sub-record belongs after moving.

Specifically, the edited sub-record is determined according to the sub-record moving operation, and the parent record to which the edited sub-record belongs before moving, that is, the first parent record, is determined. In addition, the parent record to which the edited sub-record belongs after moving, that is, the second parent record, is determined.

In the embodiment of the present disclosure, the first parent record to which the edited sub-record belongs before moving may be determined in the following manner: obtaining first description data of the edited sub-record before moving, and determining the first parent record to which the edited sub-record belongs before moving based on the first description data of the edited sub-record before moving. Similarly, the second parent record to which the edited sub-record belongs after moving may be determined in the following manner: obtaining first description data of the edited sub-record after moving, and determining the second parent record to which the edited sub-record belongs after moving based on the first description data of the edited sub-record after moving.

At step S240, change a parent record in first description data corresponding to the edited sub-record from the first parent record to the second parent record, delete description data corresponding to the edited sub-record from second description data corresponding to the first parent record, and add description data corresponding to the edited sub-record to second description data corresponding to the second parent record.

Specifically, the parent record in the first description data corresponding to the edited sub-record may be changed from the first parent record to the second parent record, so that the parent record in the first description data corresponding to the edited sub-record is the second parent record. After the change, the description data corresponding to the edited sub-record in the second description data corresponding to the first parent record may be determined, and the description data corresponding to the edited sub-record in the second description data corresponding to the first parent record may be deleted. In addition, the description data corresponding to the edited sub-record may be written into the second description data corresponding to the second parent record.

At step S250, update the display data of the target table in the target interface according to the modified first description data and the modified second description data.

According to the technical solution of the embodiment of the present disclosure, the edited sub-record is determined according to the sub-record moving operation, and the first parent record to which the edited sub-record belongs before moving and the second parent record to which the edited sub-record belongs after moving are determined. The parent record in the first description data corresponding to the edited sub-record is changed from the first parent record to the second parent record, the description data corresponding to the edited sub-record is deleted from the second description data corresponding to the first parent record, and the description data corresponding to the edited sub-record is added to the second description data corresponding to the second parent record, thereby realizing the function of performing the sub-record moving operation on the sub-record in the target table.

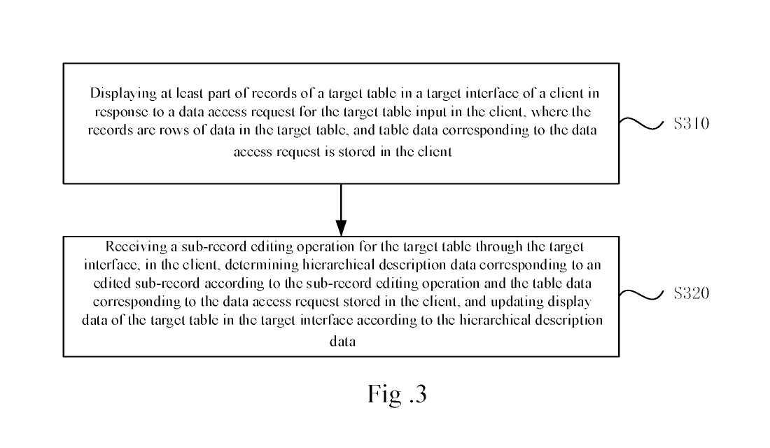

FIG. 3 is a schematic flowchart of another table data processing method according to an embodiment of the present disclosure. Based on the preceding embodiments, in the technical solution of this embodiment, optionally, table data corresponding to the data access request is stored in the client, and the updating hierarchical description data corresponding to an edited sub-record according to the sub-record editing operation, and updating display data of the target table in the target interface according to the hierarchical description data includes: in the client, determining the hierarchical description data corresponding to the edited sub-record according to the sub-record editing operation and the table data corresponding to the data access request stored in the client, and updating the display data of the target table in the target interface according to the hierarchical description data determined by the client. For the specific implementation, reference may be made to the description of this embodiment. The technical features the same as or similar to those of the preceding embodiments are not repeated here. As shown in FIG. 3, the method in this embodiment may specifically include the following steps S310 and S320.

At step S310, display at least part of records of a target table in a target interface of a client in response to a data access request for the target table input in the client, where the records are rows of data in the target table, and table data corresponding to the data access request is stored in the client.

At step S320, receive a sub-record editing operation for the target table through the target interface, determine, in the client, hierarchical description data corresponding to an edited sub-record according to the sub-record editing operation and the table data corresponding to the data access request stored in the client, and update display data of the target table in the target interface according to the hierarchical description data determined by the client.

The hierarchical description data may be used to describe parent-child relationship data corresponding to a sub-record in the target table and a parent record including the sub-record.

In the embodiment of the present disclosure, the client has the stored table data corresponding to the data access request. After the sub-record editing operation for the target table is received through the target interface, the hierarchical description data corresponding to the edited sub-record in the client may be updated according to the sub-record editing operation and the table data corresponding to the data access request stored in the client. Thus, the hierarchical description data corresponding to the edited sub-record may be obtained. Then, the display data of the target table in the target interface may be updated according to the hierarchical description data determined by the client. In the embodiment of the present disclosure, such processing may not only realize the immediate visibility of the modified target table in the client, but also ensure that the operation of the client has priority to be displayed on the screen, that is, the rendering result of the target table may be immediately seen in the client without waiting for the response from the server.

In the embodiment of the present disclosure, after the updating the display data of the target table in the target interface according to the hierarchical description data determined by the client, the method may further include: in response to that the client receives hierarchical description data corresponding to the edited sub-record sent by a server, updating the hierarchical description data corresponding to the edited sub-record stored in the client according to the received hierarchical description data; and updating the display data of the target table in the target interface according to the updated hierarchical description data in the client.

Specifically, in the case where the client receives the hierarchical description data corresponding to the edited sub-record sent by the server, the hierarchical description data corresponding to the edited sub-record stored in the client may be specifically updated according to the received hierarchical description data. Then, the display data of the target table in the target interface may be updated according to the updated hierarchical description data in the client. In the embodiment of the present disclosure, after the sub-record editing operation for the target table is received through the target interface, a message of the editing operation may be uploaded to the server, so that the server updates the hierarchical description data corresponding to the edited sub-record based on the message and sends updated hierarchical description data corresponding to the edited sub-record to the client.

It should be noted that, in the embodiment of the present disclosure, in order to ensure the consistency of the hierarchical description data between the client and the server, the hierarchical description data corresponding to the edited sub-record is determined in the client according to the sub-record editing operation and the table data corresponding to the data access request stored in the client, which does not need to be stored in the client. The hierarchical description data stored in the client may be the hierarchical description data corresponding to the edited sub-record sent by the server.

According to the technical solution of the embodiment of the present disclosure, the hierarchical description data corresponding to the edited sub-record is determined in the client according to the sub-record editing operation and the table data corresponding to the data access request stored in the client, and the display data of the target table in the target interface is updated according to the hierarchical description data determined by the client, thereby realizing the immediate visibility of the modified target table in the client and reducing the waiting time of the client.

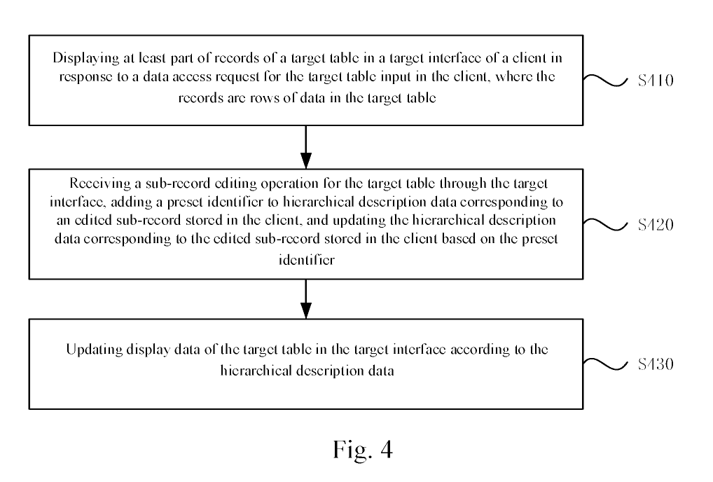

FIG. 4 is a schematic flowchart of another table data processing method according to an embodiment of the present disclosure. Based on the preceding embodiments, in the technical solution of this embodiment, optionally, the determining hierarchical description data corresponding to an edited sub-record according to the sub-record editing operation, and updating display data of the target table in the target interface according to the hierarchical description data includes: adding a preset identifier to the hierarchical description data corresponding to the edited sub-record stored in the client, and updating the hierarchical description data corresponding to the edited sub-record stored in the client based on the preset identifier. For the specific implementation, reference may be made to the description of this embodiment. The technical features the same as or similar to those of the preceding embodiments are not repeated here. As shown in FIG. 4, the method in this embodiment may specifically include the following steps S410 to S430.

At step S410, display at least part of records of a target table in a target interface of a client in response to a data access request for the target table input in the client, where the records are rows of data in the target table.

At step S420, receive a sub-record editing operation for the target table through the target interface, add a preset identifier to hierarchical description data corresponding to an edited sub-record stored in the client, and update the hierarchical description data corresponding to the edited sub-record stored in the client based on the preset identifier.

The hierarchical description data is used to describe parent-child relationship data corresponding to the sub-record in the target table and a parent record including the sub-record. The preset identifier may be used to identify whether the hierarchical description data corresponding to the edited sub-record stored in the client is accurate. In the embodiment of the present disclosure, in the case where the preset identifier is added to the hierarchical description data corresponding to the sub-record, it may be determined that the hierarchical description data corresponding to the sub-record is inaccurate. Similarly, in the case where no preset identifier is added to the hierarchical description data corresponding to the sub-record, it may be determined that the hierarchical description data corresponding to the sub-record is accurate. In the embodiment of the present disclosure, by adding the preset identifier to the hierarchical description data corresponding to the sub-record, an inaccurate record in the target table may be quickly located, so as to accurately update the inaccurate record. The preset identifier may be represented by numbers and/or letters.

Specifically, after the sub-record editing operation for the target table is received through the target interface, the hierarchical description data corresponding to the edited sub-record stored in the client may be determined. Thus, the preset identifier may be added to the hierarchical description data corresponding to the edited sub-record stored in the client. Then, the hierarchical description data corresponding to the edited sub-record stored in the client may be updated based on the preset identifier.

In the embodiment of the present disclosure, the updating the hierarchical description data corresponding to the edited sub-record stored in the client based on the preset identifier may include: first sending the sub-record editing operation to a server, so that the server updates, based on the sub-record editing operation, hierarchical description data corresponding to the edited sub-record stored in the server; and then receiving the hierarchical description data corresponding to the edited sub-record sent by the server, and updating the hierarchical description data corresponding to the edited sub-record stored in the client according to the received hierarchical description data and the preset identifier.

In the embodiment of the present disclosure, the updating the hierarchical description data corresponding to the edited sub-record stored in the client according to the received hierarchical description data and the preset identifier may be storing the received hierarchical description data into the client, and deleting the hierarchical description data added with the preset identifier; or may be replacing the hierarchical description data added with the preset identifier with the received hierarchical description data.

At step S430, update the display data of the target table in the target interface according to the hierarchical description data.

Based on the preceding embodiments, after the hierarchical description data sent by the server is received, whether display data obtained based on the hierarchical description data sent by the server is consistent with display data of the target table displayed by the client at the current moment may be determined. If not, the display data of the target table in the target interface is updated based on the hierarchical description data sent by the server. If so, the operation of updating the display data of the target table in the target interface based on the hierarchical description data sent by the server does not need to be performed, thereby realizing updating the hierarchical description data stored in the client without perception.

According to the technical solution of the embodiment of the present disclosure, the preset identifier is added to the hierarchical description data corresponding to the edited sub-record stored in the client, and the hierarchical description data corresponding to the edited sub-record stored in the client is updated based on the preset identifier, thereby realizing updating the hierarchical description data corresponding to the edited sub-record stored in the client more quickly and conveniently.

As an optional implementation of the present disclosure, the specific steps of the table processing method in this embodiment may include the following steps.

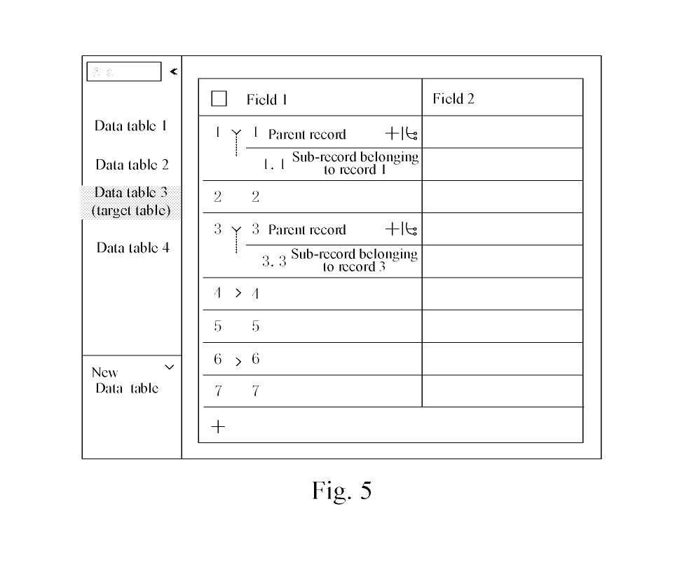

1. After the data access request for the target table input in the client is received, at least part of records of the target table may be displayed in the target interface of the client. The records are rows of data in the target table. Referring to FIG. 5, the records in the target table include parent record 1, sub-record 1.1 subordinate to parent record 1, record 2, parent record 3, sub-record 3.1 subordinate to parent record 3, record 4, record 5, record 6 and record 7.

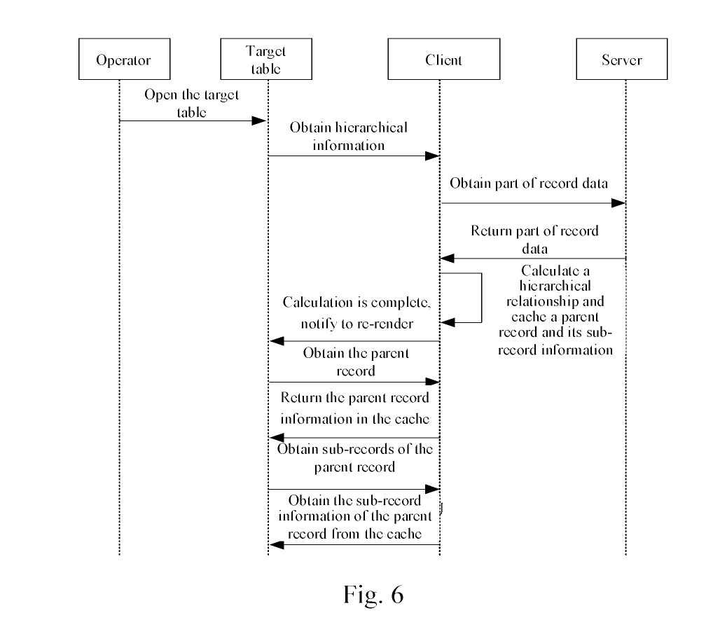

Specifically, as shown in FIG. 6, after a table open operation for the target table input by an operator in the client is received, hierarchical information (hierarchical description data) of the target table in the client may be determined, so as to acquire part of record data of the target table from the server. After the client receives the part of record data returned by the server, the hierarchical relationship of the part of records may be calculated in the client, and the parent record and its sub-records in the target table may be cached in the client. After the calculation in the client is completed, the target table may be notified to re-render the record data. The process of re-rendering the target table may specifically include: first obtaining the parent record from the cache of the client, and then obtaining the sub-records subordinate to the parent record from the cache of the client.

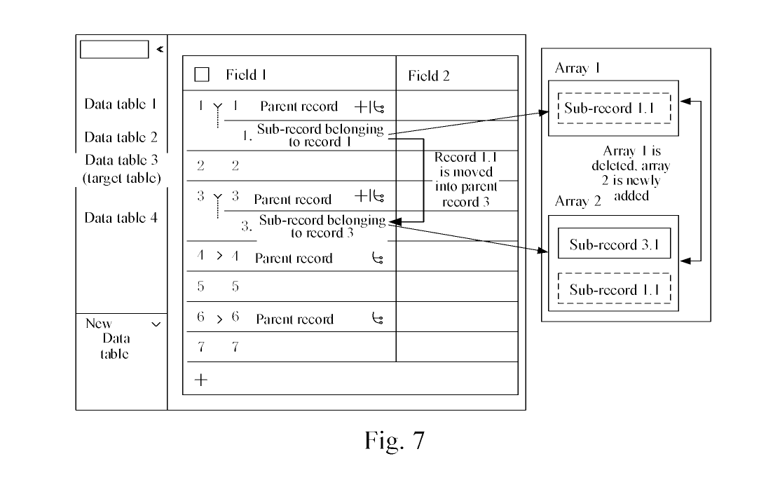

2. The sub-record editing operation for the target table is received through the target interface, and the sub-record editing operation includes a sub-record moving operation. Exemplarily, as shown in FIG. 7, a sub-record drag-and-drop operation for dragging sub-record 1.1 into parent record 3 in the target table may be received through the target interface.

3. According to the drag-and-drop operation for dragging the sub-record 1.1 of the target table into the parent record 3, it may be determined that the edited record is the sub-record 1.1, and it is determined that the parent record to which the sub-record 1.1 belongs before moving is the parent record 1 and the parent record to which the sub-record 1.1 belongs after moving is the parent record 3.

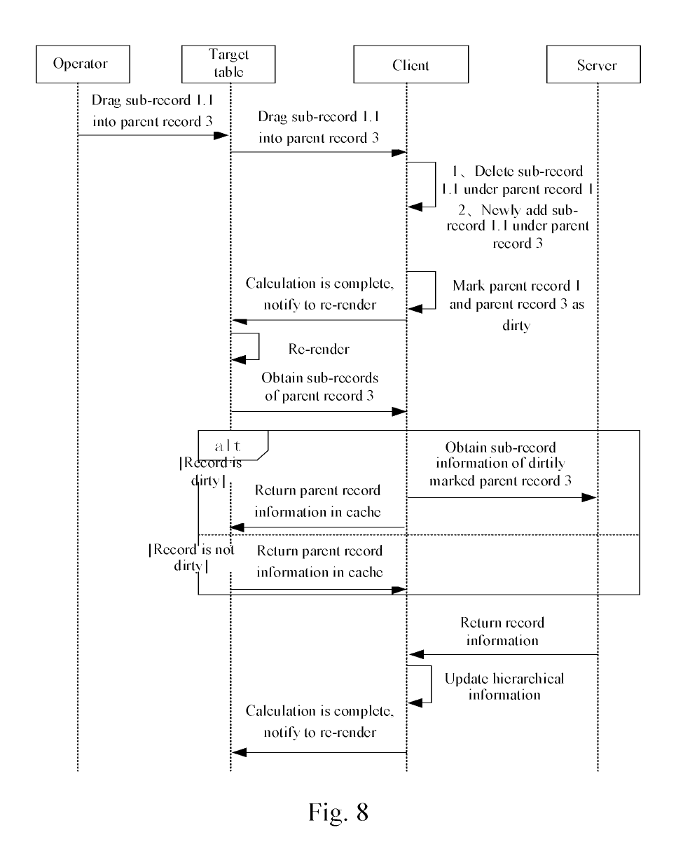

4. Then, as shown in FIG. 8, in the client, the sub-record 1.1 under the parent record 1 may be deleted and the sub-record 1.1 may be newly added under the parent record 3. In addition, local dirty marking processing may be performed on the hierarchical information of the parent record 1 and the parent record 3 stored in the client. Then, the target table may be specifically rendered based on the dirtily marked hierarchical information, so as to preferentially render the target table in the client without the need for the server to send the hierarchical information.

5. After the client deletes the sub-record 1.1 under the parent record 1 and newly adds the sub-record 1.1 under the parent record 3, the sub-record drag-and-drop operation for dragging the sub-record 1.1 into the parent record 3 in the target table may be sent to the server, so that the server updates hierarchical information corresponding to the sub-record drag-and-drop operation and sends updated hierarchical information to the client.

6. After receiving the updated hierarchical information, the client may store the updated hierarchical information, and determine whether a result of rendering the target table based on the updated hierarchical information is consistent with a result of rendering the target table by the client. If so, it may be determined that the client does not need to perform the operation of rendering the records of the target table displayed by the client based on the updated hierarchical information. If not, the target table displayed by the client may be rendered based on the updated hierarchical information, so as to adjust the records of the target table displayed by the client.

The technical solution of the embodiment of the present disclosure solves the technical problem of low table processing efficiency in existing table processing, realizes that the records of the table may be loaded on demand and the changed records may be updated more quickly and effectively in a targeted manner, and improves the processing efficiency and use experience of the table.

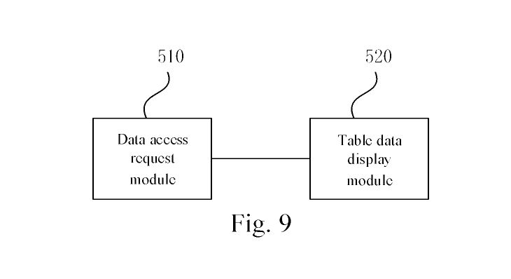

FIG. 9 is a schematic structural diagram of a table data processing apparatus according to an embodiment of the present disclosure. As shown in FIG. 9, the apparatus includes a data access request module 510 and a table data display module 520. The data access request module 510 is configured to display at least part of records of a target table in a target interface of a client in response to a data access request for the target table input in the client, where the records are rows of data in the target table. The table data display module 520 is configured to receive a sub-record editing operation for the target table through the target interface, determine hierarchical description data corresponding to an edited sub-record according to the sub-record editing operation, and update display data of the target table in the target interface according to the hierarchical description data, where the hierarchical description data is used to describe parent-child relationship data corresponding to the sub-record in the target table and a parent record including the sub-record.

According to the technical solution of the embodiment of the present disclosure, the data access request module 510 displays at least part of records of a target table in a target interface of a client in response to a data access request for the target table input in the client, where the records are rows of data in the target table, thereby realizing loading the records of the target table on demand. The table data display module 520 receives a sub-record editing operation for the target table through the target interface, determines hierarchical description data corresponding to an edited sub-record according to the sub-record editing operation, and updates display data of the target table in the target interface according to the hierarchical description data. In the technical solution, by defining the hierarchical description data that describes parent-child relationship data corresponding to a sub-record in the target table and a parent record including the sub-record, the nesting level of the records in the target table is reduced, and the data structure of the target table is simplified. After that, the display data of the target table in the target interface may be updated more quickly and specifically according to the hierarchical description data. The technical solution of the embodiments of the present disclosure solves the technical problem of low table processing efficiency in existing table processing, realizes that the records of the table may be loaded on demand and the changed records may be updated more quickly and effectively in a targeted manner without loading all data of the target table, supports quick editing and display of sub-records in a scenario of displaying the table on demand, and improves the processing efficiency and use experience of the target table.

Based on any optional technical solution in the embodiments of the present disclosure, optionally, the hierarchical description data includes first description data and second description data, the first description data is used to describe a subordinate relationship between the sub-record and the parent record to which the sub-record belongs, and the second description data is used to describe a subordinate relationship between the parent record and sub-records included in the parent record.

Based on any optional technical solution in the embodiments of the present disclosure, optionally, the sub-record editing operation includes a sub-record adding operation and/or a sub-record deleting operation, the table data display module 520 includes a first hierarchical description data determination unit, and the first hierarchical description data determination unit is configured to: in response to that the sub-record editing operation includes the sub-record adding operation, add first description data corresponding to an added sub-record, and write description data corresponding to the added sub-record into second description data of a parent record to which the added sub-record belongs; and/or, in response to that the sub-record editing operation includes the sub-record deleting operation, delete first description data corresponding to a deleted sub-record, and delete description data corresponding to the deleted sub-record from second description data of a parent record to which the deleted sub-record belongs.

Based on any optional technical solution in the embodiments of the present disclosure, optionally, the sub-record editing operation includes a sub-record moving operation. Further, the table data display module 520 may include a second hierarchical description data determination unit. The second hierarchical description data determination unit is configured to determine the edited sub-record according to the sub-record moving operation, and determine a first parent record to which the edited sub-record belongs before moving and a second parent record to which the edited sub-record belongs after moving; and change a parent record in the first description data corresponding to the edited sub-record from the first parent record to the second parent record, delete description data corresponding to the edited sub-record from the second description data corresponding to the first parent record, and add description data corresponding to the edited sub-record to second description data corresponding to the second parent record.

Based on any optional technical solution in the embodiments of the present disclosure, optionally, the hierarchical description data is stored in the form of a key-value pair, the first description data uses an identifier of the sub-record as a key and an identifier of the parent record to which the sub-record belongs as a value, and the second description data uses an identifier of the parent record as a key and identifiers of the sub-records subordinate to the parent record as values.

Based on any optional technical solution in the embodiments of the present disclosure, optionally, table data corresponding to the data access request is stored in the client. Further, the table data display module 520 may be configured to: in the client, determine the hierarchical description data corresponding to the edited sub-record according to the sub-record editing operation and the table data corresponding to the data access request stored in the client, and update the display data of the target table in the target interface according to the hierarchical description data determined by the client.

Based on any optional technical solution in the embodiments of the present disclosure, optionally, the table data processing apparatus further includes a table data update module. The table data update module may be configured to: after the display data of the target table in the target interface is updated according to the hierarchical description data determined by the client, in response to that the client receives hierarchical description data corresponding to the edited sub-record sent by the server, update the hierarchical description data corresponding to the edited sub-record stored in the client according to the received hierarchical description data, and update the display data of the target table in the target interface according to the updated hierarchical description data in the client.

Based on any optional technical solution in the embodiments of the present disclosure, optionally, the table data display module 520 includes a hierarchical description data update sub-module. The hierarchical description data update sub-module is configured to add a preset identifier to the hierarchical description data corresponding to the edited sub-record stored in the client, and update the hierarchical description data corresponding to the edited sub-record stored in the client based on the preset identifier.

Based on any optional technical solution in the embodiments of the present disclosure, optionally, the hierarchical description data update sub-module includes a server hierarchy update unit and a client hierarchy update unit. The server hierarchy update unit is configured to send the sub-record editing operation to a server, so that the server updates, based on the sub-record editing operation, hierarchical description data corresponding to the edited sub-record stored in the server. The client hierarchy update unit is configured to receive the hierarchical description data corresponding to the edited sub-record sent by the server, and update the hierarchical description data corresponding to the edited sub-record stored in the client according to the received hierarchical description data and the preset identifier.

Based on any optional technical solution in the embodiments of the present disclosure, optionally, the data access request module 510 includes a client data cache unit and a target table display unit. The client data cache unit is configured to: in response to the data access request for the target table input in the client, acquire target data corresponding to records requested to be accessed from table data of the target table stored in a server, and cache the target data in the client. The target table display unit is configured to display the target table in the target interface of the client according to the target data cached in the client.

The table data processing apparatus according to the embodiment of the present disclosure may perform the table data processing method provided by any embodiment of the present disclosure, and has corresponding functional modules and beneficial effects for performing the table data processing method.

It is worth noting that the units and modules included in the preceding apparatus are just divided according to functional logic, but are not limited to such division, as long as the corresponding functions may be implemented. In addition, the specific names of the functional units are just for distinguishing between each other, and are not used to limit the protection scope of the embodiments of the present disclosure.

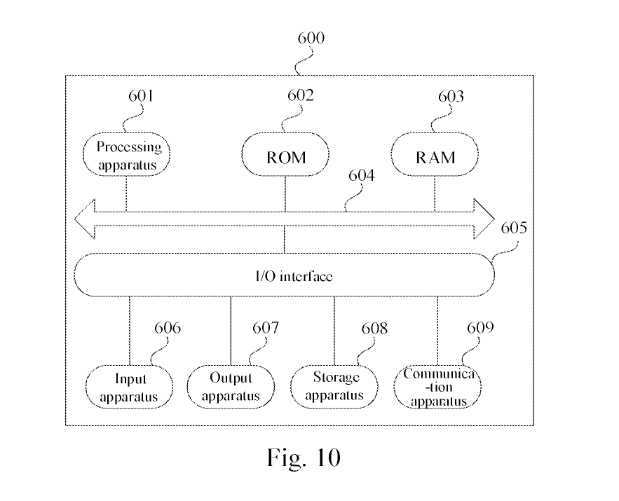

Reference is made to FIG. 10 below, which illustrates a schematic structural diagram of an electronic device (such as a terminal device or a server) 600 suitable for implementing the embodiments of the present disclosure. The terminal device in the embodiments of the present disclosure may include, but is not limited to, mobile terminals such as a mobile phone, a notebook computer, a digital broadcast receiver, a PDA (personal digital assistant), a PAD (tablet computer), a PMP (portable multimedia player), an in-vehicle terminal (e.g., an in-vehicle navigation terminal), etc., and fixed terminals such as a digital TV, a desktop computer, etc. The electronic device shown in FIG. 10 is only an example, and should not impose any limitation on the function and scope of use of the embodiments of the present disclosure.

As shown in FIG. 10, the electronic device 600 may include a processing apparatus (such as a central processing unit, a graphics processing unit, etc.) 601, which may perform various suitable actions and processing according to a program stored in a read-only memory (ROM) 602 or a program loaded from a storage apparatus 606 into a random access memory (RAM) 603. The RAM 603 further stores various programs and data required for operations of the electronic device 600. The processing apparatus 601, the ROM 602, and the RAM 603 are connected to each other through a bus 604. An input/output (I/O) interface 605 is also connected to the bus 604.

Typically, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 606 including, for example, a magnetic tape, a hard disk, etc.; and a communication apparatus 609. The communication apparatus 609 may allow the electronic device 600 to be in wireless or wired communication with other devices to exchange data. Although FIG. 10 shows the electronic device 600 having various apparatuses, it should be understood that it is not required to implement or have all the apparatuses shown. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, where the computer program contains program code for performing the method shown in the flowchart. In such an embodiment, the computer program may be downloaded and installed from a network via the communication apparatus 609, or installed from the storage apparatus 606, or installed from the ROM 602. When the computer program is executed by the processing apparatus 601, the preceding functions defined in the method of the embodiments of the present disclosure are executed.

The names of messages or information exchanged between multiple apparatuses in the implementations of the present disclosure are only for illustrative purposes, rather than limiting the scope of these messages or information.

The electronic device according to the embodiment of the present disclosure belongs to the same inventive concept as the table data processing method provided by the preceding embodiments. For technical details not described in detail in the embodiment of the present disclosure, reference may be made to the preceding embodiments, and this embodiment has the same beneficial effects as the preceding embodiments.

An embodiment of the present disclosure provides a computer storage medium having a computer program stored thereon, where the table data processing method provided by the preceding embodiments is implemented when the program is executed by a processor.

It should be noted that the preceding computer-readable medium in the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrically connected portable computer disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, a computer-readable signal medium may include a data signal propagated on a baseband or as part of a carrier wave, which carries computer-readable program code. This propagated data signal may be in multiple forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to: a wire, an optical cable, an RF (radio frequency), etc., or any suitable combination thereof.

According to one or more embodiments of the present disclosure, a table data processing method is provided, which includes: displaying at least part of records of a target table in a target interface of a client in response to a data access request for the target table input in the client, where the records are rows of data in the target table; and receiving a sub-record editing operation for the target table through the target interface, determining hierarchical description data corresponding to an edited sub-record according to the sub-record editing operation, and updating display data of the target table in the target interface according to the hierarchical description data, where the hierarchical description data is used to describe parent-child relationship data corresponding to a sub-record in the target table and a parent record including the sub-record.

According to one or more embodiments of the present disclosure, the method further includes: optionally, the hierarchical description data includes first description data and second description data, the first description data is used to describe a subordinate relationship between the sub-record and the parent record to which the sub-record belongs, and the second description data is used to describe a subordinate relationship between the parent record and sub-records included in the parent record.

According to one or more embodiments of the present disclosure, the method further includes: optionally, the sub-record editing operation includes a sub-record adding operation and/or a sub-record deleting operation, and the determining hierarchical description data corresponding to an edited sub-record according to the sub-record editing operation includes: in response to that the sub-record editing operation includes the sub-record adding operation, adding first description data corresponding to an added sub-record, and writing description data corresponding to the added sub-record into second description data of a parent record to which the added sub-record belongs; and/or, in response to that the sub-record editing operation includes the sub-record deleting operation, deleting first description data corresponding to a deleted sub-record, and deleting description data corresponding to the deleted sub-record from second description data of a parent record to which the deleted sub-record belongs.

According to one or more embodiments of the present disclosure, the method further includes: optionally, the sub-record editing operation includes a sub-record moving operation, and the determining hierarchical description data corresponding to an edited sub-record according to the sub-record editing operation includes: determining the edited sub-record according to the sub-record moving operation, and determining a first parent record to which the edited sub-record belongs before moving and a second parent record to which the edited sub-record belongs after moving; and changing a parent record in first description data corresponding to the edited sub-record from the first parent record to the second parent record, deleting description data corresponding to the edited sub-record from second description data corresponding to the first parent record, and adding description data corresponding to the edited sub-record to second description data corresponding to the second parent record.

According to one or more embodiments of the present disclosure, the method further includes: optionally, the hierarchical description data is stored in the form of a key-value pair, the first description data uses an identifier of the sub-record as a key and an identifier of the parent record to which the sub-record belongs as a value, and the second description data uses an identifier of the parent record as a key and identifiers of the sub-records subordinate to the parent record as values.

According to one or more embodiments of the present disclosure, the method further includes: optionally, table data corresponding to the data access request is stored in the client, and the updating hierarchical description data corresponding to an edited sub-record according to the sub-record editing operation, and updating display data of the target table in the target interface according to the hierarchical description data includes: in the client, determining the hierarchical description data corresponding to the edited sub-record according to the sub-record editing operation and the table data corresponding to the data access request stored in the client, and updating the display data of the target table in the target interface according to the hierarchical description data determined by the client.

According to one or more embodiments of the present disclosure, the method further includes: optionally, after the updating the display data of the target table in the target interface according to the hierarchical description data determined by the client, the method further includes: in response to that the client receives hierarchical description data corresponding to the edited sub-record sent by a server, updating the hierarchical description data corresponding to the edited sub-record stored in the client according to the received hierarchical description data; and updating the display data of the target table in the target interface according to the updated hierarchical description data in the client.

According to one or more embodiments of the present disclosure, the method further includes: optionally, the determining hierarchical description data corresponding to an edited sub-record according to the sub-record editing operation includes: adding a preset identifier to the hierarchical description data corresponding to the edited sub-record stored in the client, and updating the hierarchical description data corresponding to the edited sub-record stored in the client based on the preset identifier.

According to one or more embodiments of the present disclosure, the method further includes: optionally, the updating the hierarchical description data corresponding to the edited sub-record stored in the client based on the preset identifier includes: sending the sub-record editing operation to a server, so that the server updates, based on the sub-record editing operation, hierarchical description data corresponding to the edited sub-record stored in the server; and receiving the hierarchical description data corresponding to the edited sub-record sent by the server, and updating the hierarchical description data corresponding to the edited sub-record stored in the client according to the received hierarchical description data and the preset identifier.

According to one or more embodiments of the present disclosure, the method further includes: optionally, the displaying at least part of records of a target table in a target interface of a client in response to a data access request for the target table input in the client includes: in response to the data access request for the target table input in the client, obtaining target data corresponding to records requested to be accessed from table data of the target table stored in a server, and caching the target data in the client; and displaying the target table in the target interface of the client according to the target data cached in the client.

According to one or more embodiments of the present disclosure, a table data processing apparatus is provided, which includes: a data access request module, configured to display at least part of records of a target table in a target interface of a client in response to a data access request for the target table input in the client, where the records are rows of data in the target table; and a table data display module, configured to receive a sub-record editing operation for the target table through the target interface, determine hierarchical description data corresponding to an edited sub-record according to the sub-record editing operation, and update display data of the target table in the target interface according to the hierarchical description data, where the hierarchical description data is used to describe parent-child relationship data corresponding to a sub-record in the target table and a parent record including the sub-record.

In some implementations, the client and the server may communicate using any currently known or future developed network protocol, such as HTTP (HyperText Transfer Protocol, hypertext transfer protocol), and may be interconnected with any form or medium of digital data communication (for example, a communication network). Examples of communication networks include a local area network ("LAN"), a wide area network ("WAN"), an internet (e.g., the Internet), a peer-to-peer network (e.g., an Ad-Hoc network), and any network currently known or to be developed in the future.

The computer-readable medium may be contained in the electronic device, or it may exist alone without being assembled into the electronic device.

The computer-readable medium carries one or more programs, and when the one or more programs are executed by the electronic device, the electronic device: displays at least part of records of a target table in a target interface of a client in response to a data access request for the target table input in the client, where the records are rows of data in the target table; and receives a sub-record editing operation for the target table through the target interface, determines hierarchical description data corresponding to an edited sub-record according to the sub-record editing operation, and updates display data of the target table in the target interface according to the hierarchical description data, where the hierarchical description data is used to describe parent-child relationship data corresponding to a sub-record in the target table and a parent record including the sub-record.

The computer program code for performing the operations of the present disclosure may be written in one or more programming languages or a combination thereof, where the programming languages include, but are not limited to, object-oriented programming languages such as Java, Smalltalk, C++, and include conventional procedural programming languages such as "C" language or similar programming languages. The program code may be executed entirely on a user's computer, partly on a user's computer, as a stand-alone software package, partly on a user's computer and partly on a remote computer, or entirely on a remote computer or a server. In the case of involving a remote computer, the remote computer may be connected to a user's computer through any kind of network, including a local area network (LAN) or a wide area network (WAN), or it may be connected to an external computer (for example, connected by using Internet provided by an Internet service provider).

The flowcharts and block diagrams in the drawings illustrate the architecture, functionality, and operation of possible implementations of systems, methods and computer program products according to various embodiments of the present disclosure. In this regard, each block in the flowchart or block diagrams may represent a module, a program segment, or a portion of code that includes one or more executable instructions for implementing a specified logical function. Furthermore, it should be noted that, in some alternative implementations, functions indicated in the blocks may occur in an order different from that indicated in the drawings. For example, two blocks shown in succession may, in fact, be executed substantially concurrently, or the blocks may sometimes be executed in a reverse order, depending upon the functionality involved. It also should be noted that each block of the block diagrams and/or flowcharts, or a combination of blocks in the block diagrams and/or flowcharts may be implemented in a special purpose hardware-based system that perform a specified function or operation, or may be implemented in a combination of special purpose hardware and a computer instruction.

The modules involved in the embodiments of the present disclosure may be implemented by means of software, and may also be implemented by means of hardware. The name of a module does not constitute a limitation on the module itself under certain circumstances, for example, the data access request module may also be described as "a module for displaying at least part of records of the target table in the target interface of the client".

The functions described above herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semi-conductive system, apparatus or device, or any suitable combination of the foregoing. More specific examples of the machine-readable storage medium would include an electrical connection on the basis of one or more wires, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the foregoing.

The above description only illustrates preferred embodiments of the present disclosure and applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above disclosed concept, for example, a technical solution formed by replacing the above features with technical features with similar functions disclosed in (but not limited to) the present disclosure.

Furthermore, although the various operations are depicted in a particular order, this should not be understood as requiring that such operations should be performed in the shown particular order or in a sequential order. Under certain circumstances, multitasking and parallel processing may be advantageous. Likewise, although several specific implementation details are contained in the preceding discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. Conversely, the specific features and actions described above are merely exemplary forms of implementing the claims.

1. A table data processing method, comprising:
displaying at least part of records of a first table in a first interface of a client in response to a data access request for the first table input in the client, wherein the records are rows of data in the first table; and
receiving a sub-record editing operation for the first table through the first interface, determining hierarchical description data corresponding to an edited sub-record according to the sub-record editing operation, and updating display data of the first table in the first interface according to the hierarchical description data, wherein the hierarchical description data is used to describe parent-child relationship data corresponding to sub-record in the first table and a parent record comprising the sub-record.

2. The table data processing method according to claim 1, wherein the hierarchical description data comprises first description data and second description data, the first description data is used to describe a subordinate relationship between the sub-record and the parent record to which the sub-record belongs, and the second description data is used to describe a subordinate relationship between the parent record and the sub-record comprised in the parent record.

3. The table data processing method according to claim 2, wherein the sub-record editing operation comprises at least one selected from a group consisting of a sub-record adding operation and a sub-record deleting operation, and the determining hierarchical description data corresponding to an edited sub-record according to the sub-record editing operation, comprises:
in response to that the sub-record editing operation comprises the sub-record adding operation, adding first description data corresponding to an added sub-record, and writing description data corresponding to the added sub-record into second description data of a parent record to which the added sub-record belongs.

4. The table data processing method according to claim 2, wherein the sub-record editing operation comprises at least one selected from a group consisting of a sub-record adding operation and a sub-record deleting operation, and the determining hierarchical description data corresponding to an edited sub-record according to the sub-record editing operation, comprises:
in response to that the sub-record editing operation comprises the sub-record deleting operation, deleting the first description data corresponding to the added sub-record, and deleting description data corresponding to the added sub-record from second description data of the parent record to which the added sub-record belongs.

5. The table data processing method according to claim 2, wherein the sub-record editing operation comprises at least one selected from a group consisting of a sub-record adding operation and a sub-record deleting operation, and the determining hierarchical description data corresponding to an edited sub-record according to the sub-record editing operation, comprises:
in response to that the sub-record editing operation comprises the sub-record adding operation, adding first description data corresponding to an added sub-record, and writing description data corresponding to the added sub-record into second description data of a parent record to which the added sub-record belongs; and
in response to that the sub-record editing operation comprises the sub-record deleting operation, deleting the first description data corresponding to the added sub-record, and deleting description data corresponding to the added sub-record from second description data of the parent record to which the added sub-record belongs.

6. The table data processing method according to claim 2, wherein the sub-record editing operation comprises a sub-record moving operation, and the determining hierarchical description data corresponding to an edited sub-record according to the sub-record editing operation, comprises:
determining the edited sub-record according to the sub-record moving operation, and determining a first parent record to which the edited sub-record belongs before moving and a second parent record to which the edited sub-record belongs after moving; and
changing a parent record in first description data corresponding to the edited sub-record from the first parent record to the second parent record, deleting description data corresponding to the edited sub-record from second description data corresponding to the first parent record, and adding description data corresponding to the edited sub-record to second description data corresponding to the second parent record.

7. The table data processing method according to claim 2, wherein the hierarchical description data is stored in a form of key-value pairs, the first description data takes an identifier of the sub-record as a key and an identifier of the parent record to which the sub-record belongs as a value, and the second description data takes an identifier of the parent record as a key and identifiers of the sub-record subordinate to the parent record as values.

8. The table data processing method according to claim 1, wherein table data corresponding to the data access request is stored in the client, and the determining hierarchical description data corresponding to an edited sub-record according to the sub-record editing operation, and updating display data of the first table in the first interface according to the hierarchical description data, comprises:
in the client, determining the hierarchical description data corresponding to the edited sub-record according to the sub-record editing operation and the table data corresponding to the data access request stored in the client, and updating the display data of the first table in the first interface according to the hierarchical description data determined by the client.

9. The table data processing method according to claim 8, wherein after the updating the display data of the first table in the first interface according to the hierarchical description data determined by the client, the method further comprises:
in response to that the client receives hierarchical description data corresponding to the edited sub-record sent by a server, updating the hierarchical description data corresponding to the edited sub-record stored in the client according to the hierarchical description data received; and
updating the display data of the first table in the first interface according to the hierarchical description data updated in the client.

10. The table data processing method according to claim 1, wherein the determining hierarchical description data corresponding to an edited sub-record according to the sub-record editing operation, comprises:
adding a preset identifier to the hierarchical description data corresponding to the edited sub-record stored in the client, and updating the hierarchical description data corresponding to the edited sub-record stored in the client based on the preset identifier.

11. The table data processing method according to claim 10, wherein the updating the hierarchical description data corresponding to the edited sub-record stored in the client based on the preset identifier, comprises:
sending the sub-record editing operation to a server, so that the server updates the hierarchical description data corresponding to the edited sub-record stored in the server based on the sub-record editing operation; and
receiving the hierarchical description data corresponding to the edited sub-record sent by the server, and updating the hierarchical description data corresponding to the edited sub-record stored in the client according to the hierarchical description data received and the preset identifier.

12. The table data processing method according to claim 1, wherein the displaying at least part of records of a first table in a first interface of a client in response to a data access request for the first table input at the client, comprises:
in response to the data access request for the first table input in the client, obtaining first data corresponding to records requested to be accessed from table data of the first table stored in a server, and caching the first data in the client; and
displaying the first table in the first interface of the client according to the first data cached in the client.

13. An electronic device, comprising:
one or more processors; and
a storage apparatus, configured to store one or more programs,
when the one or more programs are executed by the one or more processors, the one or more processors are caused to implement a table data processing method,
wherein the table data processing method comprises:
displaying at least part of records of a first table in a first interface of a client in response to a data access request for the first table input in the client, wherein the records are rows of data in the first table; and
receiving a sub-record editing operation for the first table through the first interface, determining hierarchical description data corresponding to an edited sub-record according to the sub-record editing operation, and updating display data of the first table in the first interface according to the hierarchical description data, wherein the hierarchical description data is used to describe parent-child relationship data corresponding to sub-record in the first table and a parent record comprising the sub-record.

14. The electronic device according to claim 13, wherein the hierarchical description data comprises first description data and second description data, the first description data is used to describe a subordinate relationship between the sub-record and the parent record to which the sub-record belongs, and the second description data is used to describe a subordinate relationship between the parent record and the sub-record comprised in the parent record.

15. The electronic device according to claim 14, wherein the sub-record editing operation comprises at least one selected from a group consisting of a sub-record adding operation and a sub-record deleting operation, and the determining hierarchical description data corresponding to an edited sub-record according to the sub-record editing operation, comprises:
in response to that the sub-record editing operation comprises the sub-record adding operation, adding first description data corresponding to an added sub-record, and writing description data corresponding to the added sub-record into second description data of a parent record to which the added sub-record belongs.

16. The electronic device according to claim 14, wherein the sub-record editing operation comprises at least one selected from a group consisting of a sub-record adding operation and a sub-record deleting operation, and the determining hierarchical description data corresponding to an edited sub-record according to the sub-record editing operation, comprises:
in response to that the sub-record editing operation comprises the sub-record deleting operation, deleting the first description data corresponding to the added sub-record, and deleting description data corresponding to the added sub-record from second description data of the parent record to which the added sub-record belongs.

17. The electronic device according to claim 14, wherein the sub-record editing operation comprises at least one selected from a group consisting of a sub-record adding operation and a sub-record deleting operation, and the determining hierarchical description data corresponding to an edited sub-record according to the sub-record editing operation, comprises:
in response to that the sub-record editing operation comprises the sub-record adding operation, adding first description data corresponding to an added sub-record, and writing description data corresponding to the added sub-record into second description data of a parent record to which the added sub-record belongs; and
in response to that the sub-record editing operation comprises the sub-record deleting operation, deleting the first description data corresponding to the added sub-record, and deleting description data corresponding to the added sub-record from second description data of the parent record to which the added sub-record belongs.

18. The electronic device according to claim 14, wherein the sub-record editing operation comprises a sub-record moving operation, and the determining hierarchical description data corresponding to an edited sub-record according to the sub-record editing operation, comprises:
determining the edited sub-record according to the sub-record moving operation, and determining a first parent record to which the edited sub-record belongs before moving and a second parent record to which the edited sub-record belongs after moving; and
changing a parent record in first description data corresponding to the edited sub-record from the first parent record to the second parent record, deleting description data corresponding to the edited sub-record from second description data corresponding to the first parent record, and adding description data corresponding to the edited sub-record to second description data corresponding to the second parent record.

19. The electronic device according to claim 14, wherein the hierarchical description data is stored in a form of key-value pairs, the first description data takes an identifier of the sub-record as a key and an identifier of the parent record to which the sub-record belongs as a value, and the second description data takes an identifier of the parent record as a key and identifiers of the sub-record subordinate to the parent record as values.

20. A storage medium comprising computer-executable instructions, wherein the computer-executable instructions, when executed by a computer processor, are configured to perform a table data processing method,
wherein the table data processing method comprises:
displaying at least part of records of a first table in a first interface of a client in response to a data access request for the first table input in the client, wherein the records are rows of data in the first table; and
receiving a sub-record editing operation for the first table through the first interface, determining hierarchical description data corresponding to an edited sub-record according to the sub-record editing operation, and updating display data of the first table in the first interface according to the hierarchical description data, wherein the hierarchical description data is used to describe parent-child relationship data corresponding to sub-record in the first table and a parent record comprising the sub-record.
